(19) United States
(12) Patent Application Publication
(10) Pub. No.: US 2022/0001409 A1
(43) Pub. Date: Jan. 6, 2022

(54) SOFTWARE FOR OPERATING MODE FOR MATERIAL SPRAYING DEVICE AND A METHOD FOR CONTROLLING THE SPRAYING DIRECTION OF THE DEVICE

(71) Applicant: TIKKURILA OYJ, Vantaa (FI)

(72) Inventor: Matti LUOTO, Tupos (FI)

(73) Assignee: TIKKURILA OYJ, Vantaa (FI)

(21) Appl. No.: 17/291,308

(22) PCT Filed: Nov. 6, 2018
(86) PCT No.: PCT/FI2018/050815

§ 371 Date: May 5, 2021

(51) Int. Cl. B05B 12/12; B05B 13/04; B05B 15/652; G05B 15/02

(52) U.S. Cl. CPC B05B 12/12; G05B 15/02; B05B 15/652; B05B 13/0431

(57) ABSTRACT

The present invention introduces operational modes for a spraying device (501, 502), and a method for controlling the operational modes. Different operational modes comprise a wall (305) operational mode, a ceiling (306) operational mode and a holding mode for the spraying device (501, 502) with two variable options. The spraying device can be a painting device, washing device, or other treatment device capable to spray liquid material, such as paint. Other possible aspects of the present invention comprise a working tool, which can also be implemented to apply the above three different operational modes, or part of them.

### BACKGROUND OF THE INVENTION

Paint spray guns are common tools for painting walls, ceilings, objects or other kinds of surfaces which are large or difficult to approach directly. Similar kinds of devices can be used in cleaning purposes when the liquid sprayable matter is water or cleansing substance, and high pressure is used to spray the liquid material onto a desired surface. Also some working tools or remote measurement devices have common characteristics with paint spray guns in the sense that a certain distance to the wall or other surface is desired. Paint spray tools usually have an arm section whose length is fixed, and which arm section has a handle in its other end for manual grabbing of the device, allowing the user to reach more distant areas from the painter's point of view. A paint spray gun may include one or several nozzles in the other end of the arm section for outputting the paint or other liquid substance. With a plurality of nozzles lined in an orthogonal direction in relation to the movement direction of the spraying device, the user obtains a wider painting area with a single brushing movement.

Especially in painting walls, ceilings and roofs, there emerges a need to use longer arms, cranes or tools in order to reach the surfaces to be painted which locate farther from the painter him/herself. The longer the distance between the paint spray gun user and the surface to be painted, the bigger is the possibility for non-accuracy during the painting process.

In prior art, the paint spray guns with longer arms may use a fixed structure where the arm and the paint nozzles locate in a fixed mutual alignment angle. Such a construction of the spray gun with a longer arm results in that when painting e.g. a higher wall along a vertical movement of the spray gun, the paint output direction from the nozzles is different in the lower part of the wall compared to the higher part of the wall. Even a variable length arm, where the arm length could be changed by a motor, would easily result in a changing paint output direction towards the surface to be painted, and therefore the painting quality could easily get worse. The structure with a fixed mutual alignment angle between the arm direction and the nozzle direction results in the fact that only a single height level has an optimal (i.e. orthogonal) painting direction. Such a device is not practical.

In some prior art solutions, the nozzle direction could be mechanically or manually changed by rotating the nozzle around a joint, with the nozzle achieving a new angle in relation to the arm supporting the nozzle. The manual and mechanical adjustment is pretty inefficient, and requires a lot of manual work besides the actual painting process which also takes time.

It can be said that alternative traditional solutions in the field of painting devices comprise manual solutions where no intelligence is built in the device for measuring distance or angular parameters and controlling the device based on these measurements.

Prior art devices may have movement controlling intelligence in the device itself, and an example of such a device has been presented in PCT publication “WO 2016/009112” (i.e. “Vähänen 1”). This painting device comprises at least two sensors for detecting location, alignment and movement status of the painting head, and these sensors can be selected from a group of gyroscope, accelerometer and magnetometer. Furthermore, a distance detection sensor is used to measure the distance between the painting head and the closest surface to be painted. The distance detection may be implemented by a laser light transmission and reception or with an ultrasound transmission and reception, both based on reflection from the surface to be painted. A user interface (buttons, joystick, handle) is available for manual commands made by the user, including switching the device on/off and selecting “a forced painting mode”. A retractable arm can be used to tune the length of the painting arm. Vähänen 1 has a possibility to rotate the painting head (with the nozzle) around three different axial directions; X-, Y- and Z-axis directions. Vähänen 1 automatically tunes the painting head alignment angle when the painting device (the painting head) is moved along a surface to be painted e.g. by a stationary user. Thus, Vähänen 1 is a distinguished device with an intelligently controllable painting head.

Other aspects of Vähänen 1 comprise a pressurized washing device using an arm structure with a high-pressure water or other cleaning liquid to be sprayed onto a material. A further aspect is a working tool which works like a remotely controllable machine-directed screwdriver. A physical contact between a tool module and a counterpart element is thus required in this application.

It can be said that the distance detection sensor assists in finding two target distances depending on the used aspect of Vähänen 1: an optimal painting distance in the painting device application (which can be considered as a fixed distance value), and the contact situation (i.e. distance=0) in the working tool application between the tool and the counterpart. Of course, the device may have other distances from the surface because of the manual use situation, but the system tries to actively reach these target distances.

An angle locking feature is possible in Vähänen 1 by selecting through the user interface, for instance in fixing the painting head angle for a given time duration when passing a barrier, step or other kind of discontinuation in the painted surface.

Furthermore, a centralized controller unit in Vähänen 1 handles all sensor data and performs required calculations, taking also into account user input signals, and finally feeding the commands to the motors of the device. Also a screen can be added to the device of Vähänen 1 in order to show status information of the device and e.g. sensor data to the operator of the device.

Different surfaces to be painted and different locations of the surfaces in view of the human user make painting situations various. Also the painting process is desired to be controlled in a more human-controllable manner than just by keeping the distance to the painted surface correct. These issues are not handled that much in Vähänen 1.

Thus, there is a need to introduce an even more intelligent and highly practical paint spraying device where these different circumstances and locations are taken into account in using the device in an effective manner.

### SUMMARY OF THE INVENTION

The present invention introduces operational modes for a spraying device, and a method for controlling the operational modes. Different operational modes comprise a wall painting mode, a ceiling painting mode and a holding mode for the spraying device. The spraying device can be a painting device, washing device, or other treatment device capable to spray liquid material. Other possible aspects of the present invention comprise a working tool, which can also be implemented to apply the above three different operational modes, or part of them.

In other words, the present invention introduces a painting or washing or spraying device configurable to spray liquid material, wherein the device comprises a device housing, which is holdable manually by a user or configurable on a fixed or movable platform, a painting head, and a controller.

The device is characterized in that it further comprises a gyroscope and an accelerometer in connection with the painting head for sensing the positional and angular data of the painting head, wherein during painting, the controller is configured to adjust the angular alignment of the painting head in relation to the device housing so that the painting head is directed substantially orthogonally to the plane of the painted surface, during a selected operational mode.

In an embodiment of the invention, the operational modes comprise a wall operational mode and a ceiling operational mode.

In an embodiment of the invention, during a non-painting situation of the device, a selected operational mode is a holding mode when the painting head alignment in relation to the device housing remains fixed in an alignment which was present when the holding mode was switched on.

In an embodiment of the invention, when the holding mode is switched on, the device is configured to direct the painting head in a straight position, which remains until another operational mode is selected.

In an embodiment of the invention, the device further comprises user input means configured to give the user the selection possibility of the operational mode.

In an embodiment of the invention, the user input means is configured to give the user the possibility to force the spraying action on during a given manual signal.

In an embodiment of the invention, the device housing comprises an arm or several retractable arms.

In an embodiment of the invention, the controller is configured to calculate an optimum distance from the surface to be painted, and the device is configured to substantially maintain the optimum distance to the surface to be painted when the user manually moves the device housing.

In an embodiment of the invention, the user input means comprises a handle and/or a plurality of designated or programmable buttons and/or a joystick and/or a screen.

In an embodiment of the invention, means for adjusting the location and the angle of the painting head is implemented with three cylindrical motors, the motors rotating around X, Y and Z axes, and with the retractable arms.

According to a second aspect of the same invention, it comprises a working tool configurable to work with a counterpart element or with a desired surface, wherein the working tool comprises an arm or a housing, which is holdable manually by a user or configurable on a fixed or movable platform, a working tool module, and a controller.

The working tool is characterized in that the working tool further comprises a gyroscope and an accelerometer in connection with the working tool module for sensing the positional and angular data of the working tool module, wherein during set-up of the working tool towards the counterpart element or towards the desired surface, the controller is configured to adjust the angular alignment of the working tool module in relation to the arm or housing so that the working tool module is directed substantially orthogonally to the counterpart element or to the plane of the desired surface, during a selected operational mode.

In an embodiment of the invention, a user of the working tool is able to select the operational mode among a wall operational mode, a ceiling operational mode and a holding mode.

In an embodiment of the invention, a desired distance between the working tool module, and the counterpart element or the desired surface, when working operation of the working tool module is set to start, is substantially zero.

According to a third aspect of the same invention, it comprises a method for controlling a painting or washing or spraying device, or a working tool. The controlling method is characterized in that it comprises the steps of:
sensing the positional and angular data of a painting head or a working tool module by a gyroscope and an accelerometer, which are located in connection with the painting head or a working tool module,
receiving at least one user input command, comprising a selected operational mode,
adjusting the angular alignment of the painting head or a working tool module in relation to the device housing by a controller during painting so that
directing the painting head or the working tool module substantially orthogonally to the plane of the painted surface or to a counterpart element, or to a desired surface, during the selected operational mode.

In an embodiment of the invention, the operational mode can be selected among a wall operational mode, a ceiling operational mode and a holding mode.

In an embodiment of the invention, with the painting or washing or spraying device, an optimum distance is substantially maintained between the painting head and the plane of the painted surface during painting.

In an embodiment of the invention, with the working tool, a distance of zero is targeted between the working tool module, and the counterpart element or the desired surface, before working operation of the working tool module is set to start.

### BRIEF DESCRIPTION OF THE DRAWINGS

FIG. 1 illustrates general parts required in implementing operational modes in a paint spraying device according to the invention,

FIG. 2 illustrates parts and operational options in a more detailed fashion in an embodiment of the invention,

FIG. 3 illustrates an embodiment of the present invention applying a wall painting mode,

FIG. 4 illustrates an embodiment of the present invention applying a ceiling painting mode,

FIG. 5a illustrates a first embodiment of the present invention applying a holding mode,

FIG. 5b illustrates a second embodiment of the present invention applying a holding mode, and

FIG. 6 illustrates the process of intelligent controlling of the paint spraying device, a pressure washer, a liquid transport system or a working tool head.

### DETAILED DESCRIPTION OF THE INVENTION

The present invention introduces a paint spray gun or a spraying device configured to spray also other liquid material than paint (like water or any cleaning substance or a mixture of them, or fluid gel-type material), and different operational modes have been incorporated in the device, where a desired operational mode can be selected by a user of the device. The inventive idea can also be extended to operational modes of a working tool. A main embodiment is introducing operational modes for the paint spraying device and for the working tool.

In an embodiment of the invention, the spraying device has a controlling method for automatic movements and alignments of the spraying end of the device. The spraying end can also be called as the painting head, and it comprises one or more nozzles. This means that the spraying device comprises a controller and at least two different sensors for detecting location and movement status of the painting head, and also for detecting alignment status (angular pointing direction) of the painting head (i.e. the nozzle(s)). The spraying device also comprises a user interface for user input commands. The user interface can be a touch screen or it can be formed by at least one button, switch or other kinds of input means like a joystick.

In an embodiment of the invention, there are two sensors in the painting head of the invention and these two sensors are a gyroscope and an accelerometer. The gyroscope measures orientation of the painting head, and the accelerometer senses the acceleration of the painting head. From the acceleration information as a function of time, also velocity information can be obtained if the starting velocity (or reference velocity) is known (Δv=a*Δt). Furthermore, from the velocity information as a function of time, the location information can be obtained (Δs=v*Δt).

An additional sensor can be used in one embodiment of the invention, and this can be a magnetometer. The magnetometer acts as a compass and thus, it reveals the direction of the magnetic north pole.

We next refer to the drawings which illustrate the basic principle of the present invention.

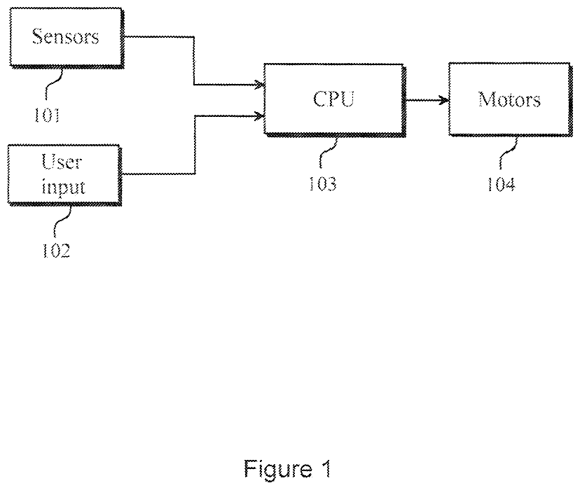

FIG. 1 illustrates the main components needed in the implementation of the operational modes according to the invention. Sensors 101 are required in the painting head for detecting movement status, movement direction and angular directional information regarding the painting head. Because the at least one nozzle is fixed to the painting head and it is an integral part of the painting head, these parameters of the painting head correspond to the speed, location and alignment information of the nozzle(s) as well. In a preferred embodiment of the present invention, a gyroscope and an accelerometer are used as fixed to the painting head.

Secondly, a user input from the user of the spraying device is enabled by having at least one type of user input means 102 on the device or in connection with the device. In case the spraying device is a mobile hand-held device comprising a handle, and possible an arm between the nozzle(s) and the handle, the user input means can be placed near the handle, pointing towards the user when holding the device in the hand of the user. In case the spraying device is connected to a crane, drone or a vehicle or robot with possibly an arm structure, the user input means can be implemented e.g. in a control panel reachable by the user. Of course, the user input could also be implemented in an external location, such as in a control room, and the control signals can be transmitted to the painting location and to the controller (i.e. the processor, or the CPU) of the spraying device through wired or wireless communication means. This application means that proper visual inspection means is available for the remote controlling and user input feeding from an external location, such as video imagery on the painting site.

The input information from the painting head (by sensors 101) and the user (by user input 102) are then fed to the central processing unit (CPU, i.e. the controller) 103 which performs the data handling, data calculations and processing steps, and finally gives commands in its output port. The calculations are discussed in detail elsewhere in the application text.

In one embodiment, it is possible that a part or all of the calculations are implemented in an external location, such as a cloud server or an external PC. In that case there are data transmission means in the spraying device for transmitting and receiving data between the spraying device and the external calculation means. It can be implemented as a wired connection or as a wireless connection.

The output commands comprising control signals for the painting head movements are fed from the CPU 103 to a group of motors 104 (i.e. comprising at least one motor). The motors 104 will enable the rotation and/or movement of the painting head to a desired location and pointing to a desired alignment angle. In one embodiment of the invention, the motors 104 comprise three motors each rotating along one of the X-, Y- or Z-axes. The arm structure can have a structure where subsequent joints comprise one motor per each joint, and each joint is rotatable according to the input signal from the CPU 103. Thus, the painting head with the nozzle(s) can be aligned in any desired direction in view of the painted surface, and also in any specified distance from the surface to be painted.

The inventive idea of the present invention takes care of the environmental fact that there are many different kinds of areas or surfaces in various different alignment angles which can be painted (or e.g. washed) with an automatically adjustable spraying device head. Therefore, the present invention introduces various operational modes which each correspond to different locations to be painted or other desired operational status for the spraying head of the painting device. The working tool application is part of the operational mode concept as well.

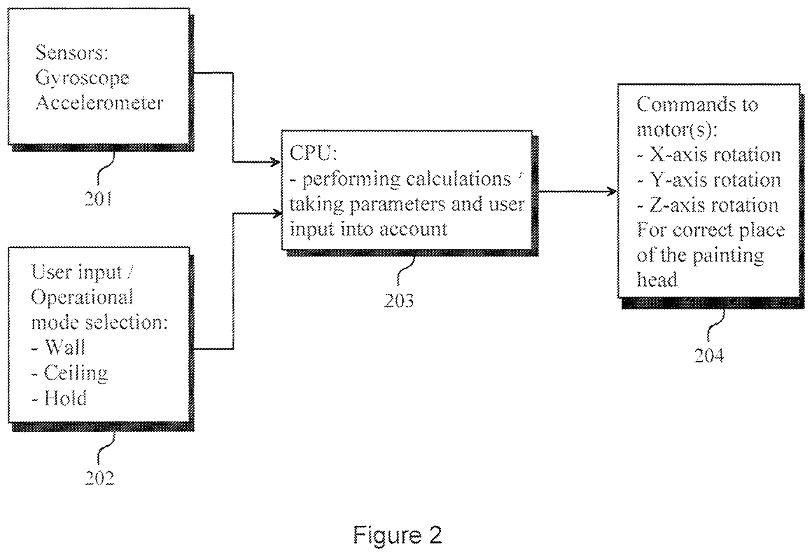

FIG. 2 illustrates a more detailed embodiment of the used sensors, possible operational modes and other operational details. In this embodiment, the system uses two different sensors 201, namely a gyroscope and an accelerometer. The system is able to track the movement status and speed of the painting head with these two sensors. This means that no distance detection sensor is required for the device to work properly and to keep its alignment angle as desired in view of the painted surface. This is also a main difference to the prior art device disclosed in WO 2016/009112” (“Vähänen 1”).

Regarding operational modes in this embodiment according to FIG. 2, there are three preferred operational modes in this example. Furthermore, it is notable that the holding mode to be selected may have two sub-options: Holding through an immediate locking of the painting head angle (first option or first embodiment of the holding mode) and the holding by at first straightening the painting head in view of the device, and keeping the straight device as locked (second option or second embodiment of the holding mode). The desired operational mode can be selected by a manual button in the user interface of the painting device. Alternatively, there can be a switch or a lever or a joystick-type of stick, with which the user can select the desired operational mode. Furthermore, it is possible that the selection is performed through a touch screen which also enables many other user input selection possibilities, e.g. switching on and/or off the device.

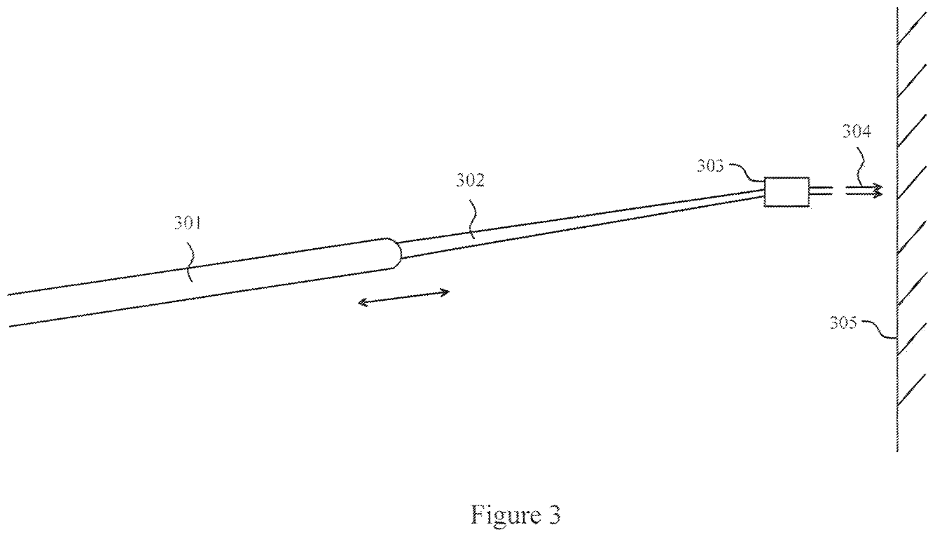

The first available operational mode is a wall painting mode in the described embodiment. The second available operational mode is a ceiling painting mode, in the corresponding embodiment. The third available operating mode is a holding mode in the same embodiment. These operational modes are discussed in the following in more detail. FIG. 3 is discussed also in connection to the first operational mode.

The first operating mode, “wall”, means that the surface to be painted is in practice a vertically aligned planar surface, i.e. a vertical wall 305. Of course, in some special embodiments, the wall to be painted can be oriented in a tilted fashion, but it is unusual in regular painting situations. With a “normal” vertically aligned wall 305, depending on the horizontal location difference between the device user (i.e. the stance location) and painted location (i.e. the location where the paint 304 hits and adheres to the wall 305) and also depending on the height of the painted location from the floor level, the alignment angle of the painting device arm 301-302 can be determined, taking also account that a certain horizontal distance needs to be present between the nozzle and the painted location on the wall. If the painting head (comprising the nozzle(s)) would be fixed to the end of the arm as a fully integrated and non-rotatable element, its spraying angle would be always the same with the alignment angle of the arm. However, in the present invention, the painting head 303 direction (i.e. the nozzle direction) in relation to the arm 302 direction can be tuned by using the motor or motors. One example of the geometry is depicted in FIG. 3. The main feature in the wall painting mode is that the painting head 303 is pointed substantially orthogonally to the plane of the wall 305 to be painted, when the paint 304 is output from the painting head 303. There are some physical, mainly mechanical, restrictions in changing the painting head 303 angle in relation to the arm 302 direction. In one example, the maximum angles can be 70 degrees to all directions, meaning that the painting head 303 is able to turn from −70 degrees to 70 degrees from left to right, and from −70 degrees to 70 degrees from downwards to upwards direction (in view of the arm 302 direction=0 degrees). This means that if the painter positions him/herself at some suitable distance from the wall 305 to be painted, he/she is able to cover much larger surface area from a stationary standpoint than with a fixed painting head direction. This is a clear advantage of such an automatically adjustable painting head 303. Of course, the 70 degrees' choice is merely a single example, and many other maximum angular values are physically and mechanically possible in the device. In one embodiment, the mechanical limit can be −90 degrees . . . 90 degrees, meaning that the user standpoint may even locate directly beneath the painting head 303, at the same distance from the wall 305 than the distance of the painting head 303 from the wall 305.

Furthermore, it should be taken into account that the painting quality would deteriorate if the paint 304 arrives to the wall 305 surface with a small angle(=much less than 90 degrees). Therefore, the prior art painting device with a fixed spraying head direction would require constant moving of the painter(=walking along the floor), and higher painting locations would be impossible to paint. This would result into poorer painting quality because there is no intelligence in the directional control of the fixed painting head. The present invention in its first embodiment solves this problem.

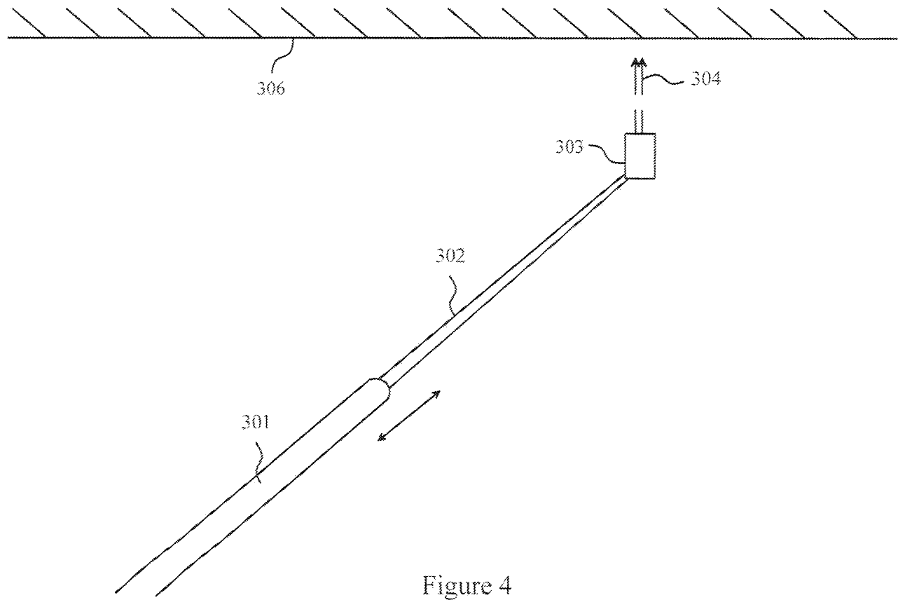

In the second operational mode, a ceiling painting mode is implemented. This situation is illustrated in FIG. 4. The parts of the painting device are the same, comprising the (possibly retractable) arms 301-302, the painting head 303, and the outputted paint 304 but the surface to be painted is the ceiling 306 in the second operational mode. This means that the target surface to be painted or sprayed is a substantially horizontally aligned plane which locates usually at least one meter from the painter's hands. Of course, in many older interiors and depending on the working position of the painter him/herself, the vertical difference between the painter's hands and the ceiling 306 can be clearly more than one meter. In some environments, the distance from the user to the painted ceiling 306 can be much more in its minimum, and with sharper angles of the device arm 302 in relation to the ceiling 306, the distance from the painter to the painted location on the ceiling 306 will increase even more but the retractable arms 301-302 solve this problem. In this situation, also the working position of the painter him/herself can be unpleasant, and thus, some automation in the painting head 303 alignment will ease the physical effort required by the user. In this way, the painter may place him/herself so that the arm 301-302 will be aligned in a tilted direction (like in FIG. 4), thus allowing a more pleasant working position for the painter. The present invention thus allows relief for the neck muscles of the painter.

In the ceiling painting mode, the criterion in the painting head 303 alignment control is to direct the painting head 303 spraying direction substantially upwards (as shown by the outcoming paint 304), no matter of the direction of the painting arm 301-302 (i.e. its longitudinal axis) in relation to the ceiling 306. In this way, the sprayed paint 304 (or other liquid) will arrive substantially orthogonally to the surface of the ceiling 306. The painting mode can be selected by the user into the ceiling painting mode through the user interface in a manual fashion, when the painter starts the ceiling painting work. In the ceiling painting mode, there are also physical constraints, i.e. a maximum angle of the painting head 303 in relation to the device body (or arm 302) direction, which determines the horizontal maximum distance between the user stance location on the floor and the horizontal coordinates of the painted position on the ceiling 306 (in case the arm lengths 301-302 are considered as fixed in this simplified example). As in the wall painting mode, the processor of the spraying device controls the direction of the painting head 303 automatically and continuously so that the painting head 303 will always spray the paint 304 in a substantially orthogonal direction in relation to the inner surface of the ceiling 306. This kind of automatic adjustment will ensure the best quality in the adhesion of the paint 304 to the ceiling 306 surface, and also less paint 304 will splash from the ceiling 306 surface in the horizontal direction. This principle of the present invention also diminishes the need for the user to walk around under each and every location to be painted on the ceiling 306.

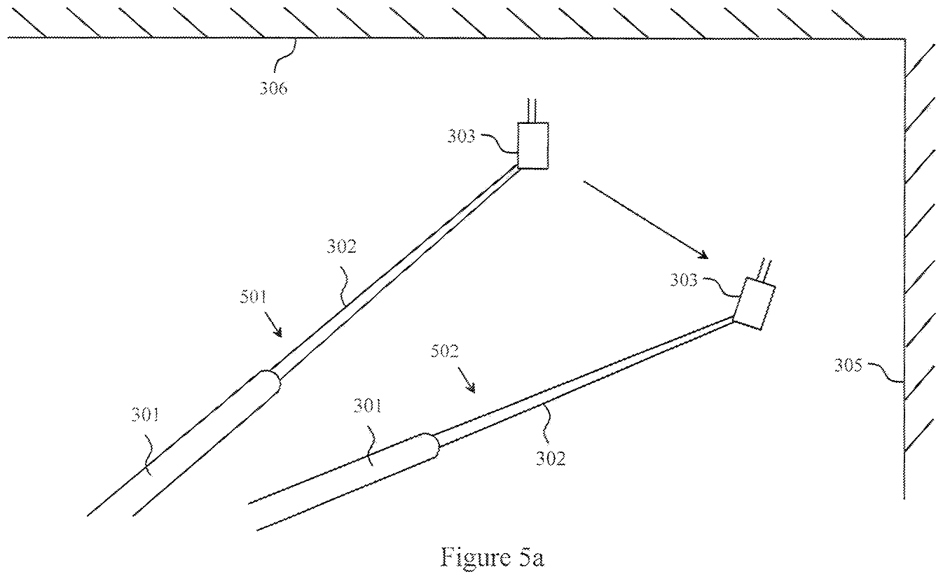

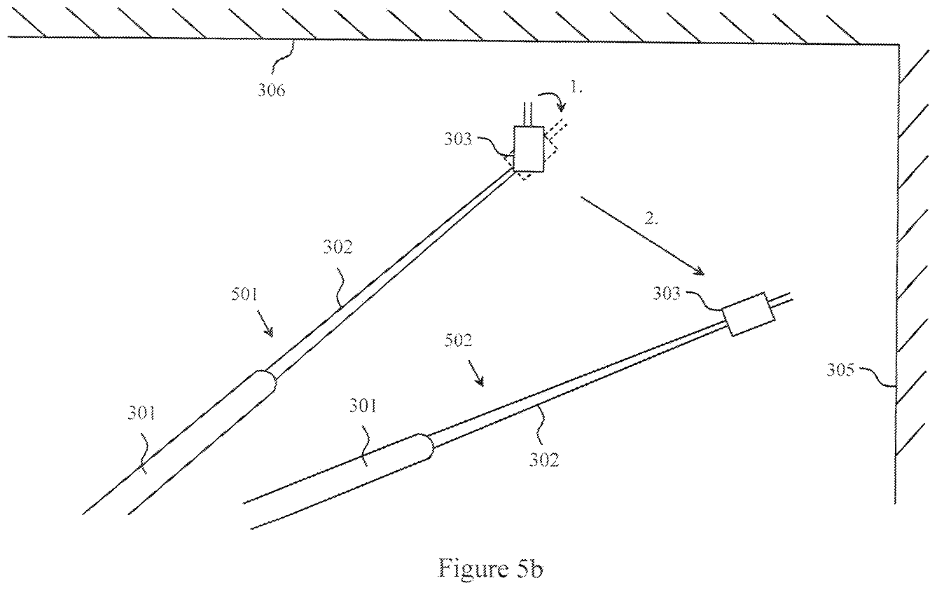

The third available operational mode in this embodiment of the invention is the holding mode. This mode is illustrated in FIG. 5a as a first embodiment of the holding mode. The holding mode means that the automatic angular adjustment of the painting head 303 is not performed when the holding mode is on. Additionally, in the first embodiment of the holding mode, the painting head 303 of the painting device will become and remain stiff right after the holding on is switched on, i.e. the painting head will stay fixed in the angular alignment which the painting head 303 had when the user switched the holding mode on through the user interface. This operational mode is simple and it does not need any active measurement to be performed by the sensors.

As FIG. 5a shows, the left-hand side painting device 501 shows the moment when the user switches the holding mode on. Therefore, the alignment angle of the painting head 303 is vertical, pointing directly towards the ceiling 306 (assuming that the ceiling painting mode was applied, when the holding mode is switched on). The right-hand side painting device 502 illustrates the same device after the user has lowered the painting head 303 to a new location and/or alignment in the direction of the arrow, and the holding mode has been on during this movement. As it can be seen, the alignment angle of the painting head 303 in relation to the arm 302 direction remains the same in painting device 502 as it was in the painting device 501 during the holding mode switch-on. This angle remains the same, i.e. the angular tuning for the painting head 303 is not performed during the time when the holding mode is on. In other words, the painting device 501, 502 remains intrinsically fixed, and it can be moved in any position or location or even to a rest position, whatever is desired by the user of the device.

The tuning of the painting head alignment angle will start once again when the holding mode is released by selecting another operational mode through the user interface.

FIG. 5b illustrates a second embodiment of the holding mode. In this embodiment, when the holding mode is switched on, the controller is configured to first straighten the painting head 303 in relation of the arm 302 shown as the step “1” in FIG. 5b. Thereafter, the painting head 303 will remain fixed, until another operational mode is selected by the user. The step “2” illustrates the painting device movement by the user from a first position to a second position, where the painting head alignment will remain straight in relation to the arms 301, 302 of the device (or 0° or in the center among all possible angles between the painting head 303 and the rest of the device). In summary, the device will control the intrinsic change (“1”) of the painting head angle right after the holding mode is switched on. Thereafter, the movement according to arrow “2” depicts the free movement of the fixed device made by the user manually when the holding mode remains as “on”.

In the second embodiment as well, the tuning of the painting head alignment angle will start once again when the holding mode is released by selecting another operational mode through the user interface.

In other words, discussing the second embodiment of the holding mode, the device is configured to direct the painting head 303 in a straight position, when the holding mode is switched on, and the straight position remains until another operational mode is selected. The straight position means that the painting head 303 (meaning its nozzles) will point to the same direction as the arm 302 of the device, directly and symmetrically in relation to the device. In other words, the center position or 0° position can be defined for the painting head 303 in relation to the rest of the painting device when the second embodiment of the holding mode is on.

The user interface may have buttons named like “Hold, keep the angle” and “Hold, by straightening the device first” available for the user to select either one of the holding modes.

A second aspect of the present invention is a pressurized washing device using an arm structure and water (or other cleaning liquid) in order to direct high-pressure water or other liquid material spray onto a material to be cleaned or washed. The above discussed operational modes are directly applicable for the second aspect as well.

A third aspect of the present invention is a working tool which may have an arm and a working tool module, like a remotely controllable machine-directed screwdriver, for instance. In this aspect, it is essential to get a physical contact between the working tool module and the counterpart element which the working tool module is affecting. In the working tool aspect, the operational mode can be selected according to the surface where the operable screw locates, such as by selecting the wall operational mode when working with screws locating on the wall 305. The device will align the working tool module in an orthogonal direction in view of the vertical wall 305, and then, the horizontally aligned working tool module can be moved directly into contact with the counterpart on the wall 305. The 90° alignment in view of the wall plane direction remains all the time, when the movement towards the wall 305 is performed. When the physical contact is obtained between the working tool module and the counterpart element on the wall 305, the working tool can be operated through an input command performed with the user interface, such as pressing a manual button.

The ceiling operational mode can be similarly used for counterpart elements locating on the ceiling 306, as the wall operational mode above. In that situation with the ceiling operational mode, the direction of the working tool module points directly upwards, in 90° angle towards the plane of the ceiling 306.

The holding mode is probably most usable in situations where the user moves (i.e. walks) directly in front of the next counterpart element, and the next counterpart element locates on the same height of the wall than the previously worked counterpart element. There, the fixed angle works well when working with several counterparts subsequently with the working tool. In that situation, the holding mode with a working tool is applicable and beneficial. Especially the first holding mode as discussed in FIG. 5a is advantageous using such sequential movement of the working tool.

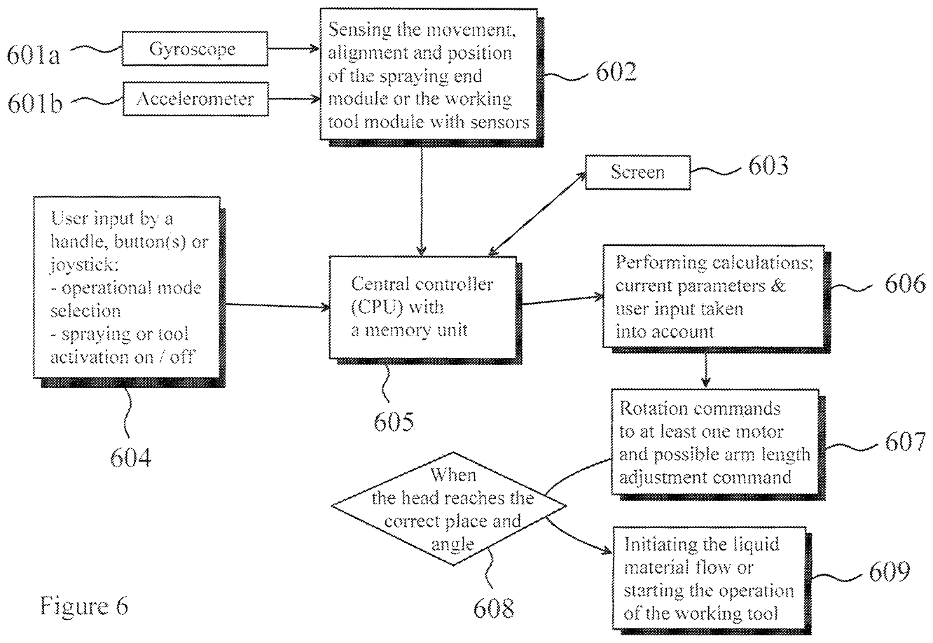

FIG. 6 illustrates the process of intelligent controlling of the paint spraying device, a pressure washer, a liquid transport system, or a working tool module. At first, the sensors 601a-b fixed or connected on the spraying end module (like e.g. a painting head) or on the working tool module measure a current position (absolute coordinates), its alignment data (nozzle head or tool head angle) and movement (speed and/or acceleration of the spraying end module or the working tool module) in step 602. The exemplary sensors to be used are a gyroscope 601a for measuring orientation of the end module, and an accelerometer 601b for measuring its acceleration (and using the equations a=Δv/Δt and v=Δs/Δt; achieving the movement data along three different axes). All sensed and measured information can be saved to the memory unit and thus fed to the calculation logic of the system, i.e. to a central controller 605 (“CPU”, or other kind of a data processing unit). User input 604 commands are given with specific means (such as e.g. a handle, button(s) or joystick) available manually to the user and the user input signals are fed to the central controller 605 as well. The user input 604 commands comprise the operational mode selection according to the invention, and further, the user may enable the spraying action or tool activation to be on or off. When the spraying action or tool activation is on, the device will automatically spray the liquid or rotate the screw, when the correct distance and alignment is reached for the painting head or working tool module after the intelligent tuning of the painting head position and alignment. Alternatively, this on/off button (or other means) can be used as a “dead man's switch”, where the device sprays the liquid or rotates the screw only when the on/off-button is pressed by the user. The device may have a screen 603 which acts as device output interface to the user. In an embodiment, the user input 604 means can be implemented as a touch screen, which then integrates the functionalities of elements 603 and 604.

Apart from the manual signals given by the user, the painting head has automated position and alignment tuning based on measured information through the sensors 601a-b. The central computer or controller 605 then calculates magnitude and direction of a required correction to the current location and angle of the device's painting head (or the working tool module). If there is a need for correcting the painting head location or alignment, the central controller 605 will calculate a required change or compensation 606 needed for the painting head location and its angle. The sensor data achieved from the sensors 601a-601b may be fed to a Kalman filter which can handle non-idealities in the form of noise in the sensor data, and also recursively it can take the previous sensor results into analysis when estimating the following state (location and angle) of the system. Different sensors can be weighed with various and selectable coefficients in the calculations. The calculation algorithms for the absolute location, angle and distance to the closest object can be implemented as a single software block or by several separate computer program code scripts available in the memory unit and executed by the controller. When the compensation results are ready, this information is triggered into rotation commands 607 for the motor or motors. The command signals can be fed simultaneously to the motors, and the motor rotation movements can be simultaneously triggered for quick realization of the painting head correction. The arm lengths can be adjusted as well if the joints between the arm sections are motorized.

If desired, the system may rely on single calculation round during correcting the position and alignment of the painting head. Still, in another embodiment, it is possible to re-measure the new device environment with the two different sensors 601a-601b after making a correction movement through rotation by at least one motor. The newly sensed information may be used in refining the correction magnitude (for both the position and the angle) and therefore, the correction can be made even better regarding the achieved accuracy.

The condition 608 regarding reaching the correct place and achieving the correct and desired angle of the painting head towards the closest surface is fulfilled when the rotation orders have been implemented and each motor has concluded its movement. The desired angle is substantially 90 degrees with the first and second operational modes.

The operation of the motors can be selected wisely so that in case of extremely narrow spaces to be reached, the motors can be operated sequentially in a way where no collision happens with an obstacle. It may be beneficial to e.g. first operate the arm length motor with a protruding movement (increasing the arm length) and after that, to progress with the three motors capable of finding the right angle towards the painted surface.

When the correction movement has been finished, the central controller 605 will in one embodiment trigger the initiation 609 of the fluid transport towards the painting head and out towards the surface (wall or ceiling), where the effect of the liquid is desired. Regarding the working tool operation embodiment, this step will initiate the operation like starting the rotation of the screwdriver head in a desired rotational direction. In another embodiment, the initiation of the liquid flow or the rotation of the working tool module can be done manually (e.g. through the on/off switch pressable by the user). In the latter case, also stopping of the liquid flow or stopping of the working tool module rotation can be performed manually (e.g. by releasing the on/off switch).

In all the embodiments, paint can be replaced with water, other liquid, or liquid-based material (such as a gel, or a liquid solution comprising solid particles) which is capable of flowing and to be sprayed on any desired place or surface, or just outwards from the nozzle working as the end module output (i.e. as the painting head). Such a place where the sprayed liquid material is directed to, may thus also be air or even a vacuum, like the way a fountain works. The liquid material to be sprayed could even be replaced by some solid material, e.g. like small rocks, crushed gravel or sand used in a sanding machine in freezing or other circumstances where friction to the ground needs to be increased. Another possible example of a solid material to be sprayed is a snow making machine used in downhill skiing centers, or a tennis ball cannon used for consistent ball hitting during a tennis practice session.

In yet another possible option, the device may be configured to spray gaseous materials, such as e.g. air, from its nozzles.

In an embodiment of the apparatus, a centralized controller unit handles gathering of the sensor information, required calculations, handling user input signals, and giving commands to the motors through the wirings inside the arm structure. The controller unit may be physically located near the handle of the spraying device. A different way of implementing the controller is using a wireless transceiver in the spraying device and operating the spraying device externally through a remotely located computer. In such an embodiment, the microprocessor of the computer or server works as a controller as mentioned in the above.

With an external computer which performs calculations and commands to the spraying device, it is possible for control the painting or washing process from a suitable interior like inside the building whose ceiling is being treated on the outside, or from a vehicle used by the service provider which may be parked in a close vicinity of the treated surface.

As a useful tool for any user handling or operating the spraying device in practice, the device itself may be provided with a screen capable of showing various apparatus information, sensor data, or any other kind of application data to the user or the operator of the spraying device. The information may include device status information and alarm data as well. The screen can be attached in close proximity to the operator's (i.e. user's) handle of the device. Another option for showing the application or device parameters to the user is to present the information on the screen of the remotely locating computer or server. In one embodiment of the invention, the screen may be used as a user input interface as well through touch screen functionalities.

The device naturally requires electrical supply power in some form. This may be achieved through a battery or set of batteries fixed to an appropriate battery holding space of the device or through mains current input onto which the spraying device is connected. When the mains current is connected to the device, the less than fully charged battery can then be loaded simultaneously.

Similarly as the electrical supply, the device needs a main material input bus like a paint input pipe connected with a sufficiently large paint storage volume, or a water pipe together with a connection to a water tank or water supply. For situations where the main material input flow needs to be interrupted for some reason, like in an especially tight area where the painting is performed, there can be provided a smaller reserve material tank connected to the spraying device. This can be also called as an intermediate tank. When there is any need to cut the connection to the main input pipe coming from the paint or water storage, the reserve tank will be switched on, and the most difficult spaces, for instance, could be painted without any restrictive input hoses or pipes connected to the spraying device. The system can be provided with a compressor which provides a needed pressure level when the battery supply is used as the input power. In one embodiment, the reserve material tank may have a volume between 1 litre to 10 litres, and it can be fixed directly to the device near its gripping part. Another exemplary option is to set the reserve material tank and the compressor in a backpack which is carried by the user of the device.

The present invention is generally suitable for various liquid transport systems where the location and the angular direction of the transport system's output is required to be tracked or directed for any reason. Another possible application area is to use the invention with a specific tool, e.g. with a machine-directed screwdriver or in other kinds of utensils or instruments which may have a specifically shaped arm or head for grabbing or processing any material or object. The screwdriver application is a useful one because the exact placement of the tool's head and also the alignment direction onto the screw is essential for the tool to be successfully used. Also, the locations and the face directions can be tricky regarding the accessibility to the site itself. The present invention allows any tool with a controllable processing or grabbing head to be used remotely with or without a specific arm, giving access to places not otherwise easily accessible to be worked with. With the present invention, working tools may be used successfully without extensive cranes or support structures required on the scene.

The controlling of the painting device and the working tool is performed by the controller, which executes the commands and intelligent tuning of the device head through a computer program. The computer program can be saved in a memory of the painting device or a working tool. Alternatively, the computer program can be downloaded to be executed by the controller from an external location, such as an external server or PC, or from a cloud computing service. The manual commands from the user are fed to the controller as well, giving appropriate control commands based on intelligent measurements and the user commands. The control commands may affect the lengths of the arms 301-302 of the device, the intelligent direction control of the painting head 303 or a working tool module, and the active time periods, when the paint 304 or liquid is sprayed on the desired surface, or when the working tool module is set to e.g. rotate the screw on the wall. This idea of course comprises other possible manners of working or acting on the counterpart or the desired surface with the working tool module.

Generally speaking, the present invention is useful for correcting any movement error or vibration or mistakes in painting or washing processes. A second benefit is that during painting larger surfaces like high and large wall surfaces, the prior art solution like painting devices with a fixed-angle nozzle will result in varying arrival angles for the paint or water in relation to the affected surface. With the present invention with an intelligent location and angle tuning system for the end module (the painting head), the arrival angle of the paint towards the surface can be tuned intelligently to substantially orthogonal direction in view of the painted surface. This enhances the paint adhesion and the overall quality of the painting dramatically. Regarding any tool head operation remotely with the principles of the invention, much easier access to the operated location may be achieved without specific cranes or support structures which would have to otherwise be built for the tool operator him/herself. A further advantage is the possibility to make the device more portable and movable in smaller spaces, when the local battery is used as the power supply and the smaller reserve paint or water tank is locally taken into use.

A further option for the invention is to use it with industrial robots, like on a production line of a factory with automatically operated arms. The intelligent sensing and movement control of the device head module is directly applicable to situations where industrial robots are used in manufacturing of the devices, like in assembling and painting new cars. This is an advantageous application area as well for the present invention.

A machined screwdriver operation in difficult locations is an example of the invention in the area of working tools. The present invention has the advantage that difficult or even impossible locations for manual screwdriver use can be overcome with the working tool according to the present invention.

The present invention is not restricted merely to the embodiments disclosed above, but the scope of the present invention is defined by the claims.

1. A painting or washing or spraying device configurable to spray liquid material, wherein the device comprises
a device housing, which is holdable manually by a user or configurable on a fixed or movable platform,
a painting head, and
a controller,
the device further comprising
a gyroscope and an accelerometer in connection with the painting head for sensing the positional and angular data of the painting head,
wherein during painting, the controller is configured to adjust the angular alignment of the painting head in relation to the device housing so that
the painting head is directed substantially orthogonally to the plane of the painted surface, during a selected operational mode.

2. The device according to claim 1, wherein the operational modes comprise a wall operational mode and a ceiling operational mode.

3. The device according to claim 1, wherein during a non-painting situation of the device, a selected operational mode is a holding mode when the painting head alignment in relation to the device housing remains fixed in an alignment which was present when the holding mode was switched on.

4. The device according to claim 1, wherein when the holding mode is switched on, the device is configured to direct the painting head in a straight position, which remains until another operational mode is selected.

5. The device according to claim 1, further comprising user input means configured to give the user the selection possibility of the operational mode.

6. The device according to claim 5, wherein the user input means is configured to give the user the possibility to force the spraying action on during a given manual signal.

7. The device according to claim 1, wherein the device housing comprises an arm or several retractable arms.

8. The device according to claim 1, wherein the controller is configured to calculate an optimum distance from the surface to be painted, and the device is configured to substantially maintain the optimum distance to the surface to be painted when the user manually moves the device housing.

9. The device according to claim 1, wherein the user input means comprises a handle and/or a plurality of designated or programmable buttons and/or a joystick and/or a screen.

10. The device according to claim 1, wherein the means for adjusting the location and the angle of the painting head is implemented with three cylindrical motors, the motors rotating around X, Y and Z axes, and with the retractable arms.

11. A working tool configurable to work with a counterpart element or with a desired surface, wherein the working tool comprises:
an arm or a housing, which is holdable manually by a user or configurable on a fixed or movable platform,
a working tool module, and
a controller,
the working tool further comprising
a gyroscope and an accelerometer in connection with the working tool module for sensing the positional and angular data of the working tool module,
wherein during set-up of the working tool towards the counterpart element or towards the desired surface, the controller is configured to adjust the angular alignment of the working tool module in relation to the arm or housing so that
the working tool module is directed substantially orthogonally to the counterpart element or to the plane of the desired surface, during a selected operational mode.

12. The working tool according to claim 11, wherein a user of the working tool is able to select the operational mode among a wall operational mode, a ceiling operational mode and a holding mode.

13. The working tool according to claim 11, wherein a desired distance between the working tool module, and the counterpart element or the desired surface, when working operation of the working tool module is set to start, is substantially zero.

14. A method for controlling a painting or washing or spraying device, or a working tool, the method comprising the steps of:
sensing the positional and angular data of a painting head or a working tool module by a gyroscope and an accelerometer, which are located in connection with the painting head or a working tool module,
receiving at least one user input command, comprising a selected operational mode,
adjusting the angular alignment of the painting head or a working tool module in relation to the device housing by a controller during painting so that
directing the painting head or the working tool module substantially orthogonally to the plane of the painted surface or to a counterpart element, or to a desired surface, during the selected operational mode.

15. The method according to claim 14, wherein the operational mode can be selected among a wall operational mode, a ceiling operational mode and a holding mode.

16. The method according to claim 14, wherein with the painting or washing or spraying device, an optimum distance is substantially maintained between the painting head and the plane of the painted surface during painting.

17. The method according to claim 14, wherein with the working tool, a distance of zero is targeted between the working tool module, and the counterpart element or the desired surface, before working operation of the working tool module is set to start.
